(19) United States
(12) Patent Application Publication
(10) Pub. No.: US 2020/0117735 A1
(43) Pub. Date: Apr. 16, 2020

(54) METHOD FOR IDENTIFYING COMPLEX TEXTUAL PATTERNS CONTAINING KEYWORDS WITHIN DATA RECORDS

(71) Applicant: CA, Inc., New York, NY (US)

(72) Inventor: Gregory Michael Berres, Batavia, IL (US)

(21) Appl. No.: 16/160,663

(22) Filed: Oct. 15, 2018

(51) Int. Cl. G06F 17/30

(52) U.S. Cl. CPC G06F 17/30395; G06F 17/30463

(57) ABSTRACT

Technology for the improved processing of search queries is provided. Embodiments of the present invention are directed to simple and efficient methods, system, and computer storage media for improving search systems to find relevant search results based on the one or more keywords of the search query. Chain search metadata is used to complete a search query. The chain search metadata includes links that comprise the chain structure and define how a search is performed. Each link include a trie data structure and maximum keyword length, before section, and an after section. In one embodiment a search is performed first from the collected execution metrics.

### BACKGROUND

When searching a database to locate all occurrences of a particular word or phrase, traditional search methods are slow. Computer software has been used to search databases, however, this type of “keyword match searching” requires significant resources making the search is impractical (e.g., computationally inefficient and costly). Typical keyword match searching does not always return the best search results when the search query does not precisely match any stored electronic information. Keyword match searching and other conventional search systems generally have no method of compensating for search terms that return only a few search results, or no search results at all. Further, keyword match searching systems struggle to search for complex textual patterns.

Various software techniques have been used to organize the data for typical searches. These techniques usually involve indexing schemes in which large tables contain locations of items in the database. These index tables may be comparable in size to the actual data base, and they are often cumbersome to build and organize. Moreover, a system that requires indexing tables is inconvenient to use for searching databases because the content varies with time.

### SUMMARY

Embodiments of the present invention relate to methods, systems, and computer storage media for providing matches to complex textual patterns containing keywords within sequential data records. To do so, a chain structure having chain search metadata is used to search a complex search request. The chain search metadata defines a plurality of links of the chain structure where each link has instructions (search elements) for how to perform searching and matching of the complex search request. A search is executed by proceeding sequentially through the plurality of links. Each link may search for only a segment of the complex search request. Search elements include using a trie data structure to identify keywords and matching characters that precede and follow the keywords.

In some embodiments, execution metrics are collected from each of the links. The execution metrics include the number of matches the link returned. The execution metrics are used to dynamically adjust the order of link execution. Dynamically adjusting the order of link execution overcomes many problems encountered by previous methods. Adjusting the order of link execution allows the system to optimize subsequent searches of other records. The dynamic adjustment may place links that give fewer results earlier in the chain data structure in order to lower the volume of data searched in subsequent links.

In some embodiments, as the search is executed, proceeding sequentially through the order of links for their respective sections of the search query, if any link does not present at least one match, the remaining links are not executed for that record. Instead, execution metrics are collected and the order of link execution may be dynamically adjusted. The search continues utilizing the dynamically adjusted order of link execution for a subsequent record.

### BRIEF DESCRIPTION OF THE DRAWINGS

The present technology is described in detail below with reference to the attached drawing figures, wherein:

FIG. 1 is a flow chart of an example process for searching using a chain structure, in accordance with an embodiment described herein;

FIG. 2 is an example of how the order of link execution may change, in accordance with an embodiment described herein;

FIG. 3 is a flowchart showing the relationship between the chain structure and dynamic adjustment of link execution for “n” number of records, in accordance with an embodiment described herein;

FIG. 4 shows exemplary chain search metadata for various links of a chain structure, in accordance with an embodiment described herein; and

FIG. 5 is an example computing device suitable for embodiments described herein.

### DETAILED DESCRIPTION OF THE INVENTION

Search systems support identifying, for received search queries, search query results from databases. A database may be a series of public records. A search query, having one or more keywords, can be executed using a search system to find relevant search results based on the one or more keywords of the search query.

In conventional search systems, the database is searched using either “keyword match searching” or a series of index tables. “Keyword match searching” requires significant resources making the search is impractical (e.g., computationally inefficient and costly). Typical keyword match searching does not always return the best search results when the search query does not precisely match any stored electronic information. Indexing schemes fail to fix the issues of typical keyword match searching. These techniques usually involve indexing schemes in which large tables contain locations of items in the database. These index tables may be comparable in size to the actual data base, and they are often cumbersome to build and organize.

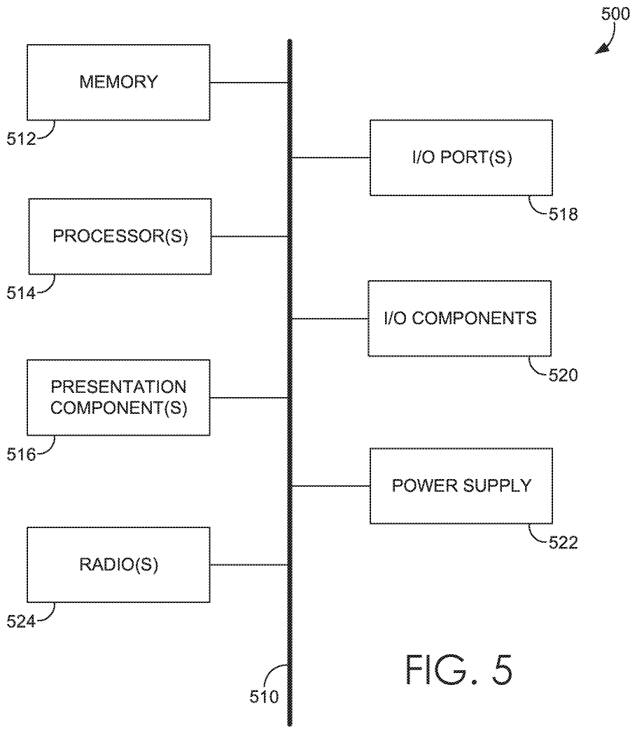

The technology provided by the disclosure not only improves search technology in a computing environment, but it also improves computing hardware and the function of the computer during the process of identifying and returning semantically meaningful search results. For example, at least one processor, such as the example processor later described with FIG. 5, generally has a finite amount of processing power. By reducing the processing power demanded on the processor, the remaining processing power is freed up to be used for other computational activities. Thus, a computer employing the processor is made more efficient by more effective use of its processing power.

The described technology reduces the processing demand of the computer processor, and thereby makes the computer more efficient. In some embodiments described herein, the net benefit is approximately an 85% reduction in CPU usage over previously used methods. The technology provided alleviates loads on processors by (in some embodiments) proceeding to subsequent search elements within the chain where each subsequent search element presents a match or a number of matches.

The described technology also includes methods that are not routinely performed in the field of this technology. It is not a routine or well-understood activity in this technological field to have a plurality of links within a chain structure and specifically where the links comprise a trie data structure, a maximum keyword length, a before section, and an after section.

Further, the described technology is not just limited to the plurality of links, but the described dynamic adjustment of the order of link execution within the chain structure. As a search is executed, execution metrics are collected on each link, the order of these links are then arranged according to these execution metrics to provide an order of execution. As described herein, this dynamic adjustment allows the execution of the search to be significantly quicker and more efficient than conventional searches. The combination of each of these methods, proceeding sequentially within each link along the various methods, and dynamically adjusting the order of links based on execution metrics is not routine in the field of this technology.

Embodiments of the present invention are directed to methods, systems, and computer storage media for a combination of search trie data structures in conjunction with regular expression to quickly identify complex patterns containing keywords within textual data records. In particular, a search is executed on a series of records. The search is performed using a chain structure comprising a series of links. Chain search metadata defines the series of links that makes up the chain structure. The instructions in each of the links are the search elements. The search elements are used sequentially as defined by the link to execute the search.

The search is executed against data records or a plurality of records. The search executes using each of the search elements in each link seeking matches within the plurality of records. A “match” is the piece of text, or sequence of bytes or characters (i.e., “a pattern”) that indicate the pattern was found in a record.

Example A, a search query is for the address of a person. Chain search metadata may be initially received. When the search query is received, the first link in the chain structure is executed against a first record. The first link will have a series of search elements sequentially ordered. The search will proceed through each of these search elements in sequential order. Once all search elements of the first link are executed, any subsequent link is similarly executed before moving to the next record.

The search elements within each link include a trie data structure and a maximum keyword length, a before section, and an after section. The trie data structure is made up of keywords which may be stored in a file or database (a keyword database). Keywords may be populated using a thesaurus to sets of characters or words within a dictionary or thesaurus. The keywords may have a set of pointers to children nodes which may be extensions of characters. These children nodes can be variations of the keyword, including suffixes like verb tense such as “ed” and “ing” and prefixes such as “re.” In one embodiment, all children nodes are prepopulated within the dictionary.

Revisiting Example A, where the search query was for an address, if only a few characters were known for the address, such as “ma” in the USA, the trie data structure could seek, potentially from a dictionary, a list of street names in the United States. Keywords from the dictionary that include the characters “ma” would be populated, some keywords populated may include Main, Massachusetts, Malboro, Damascus, and Margarine. Then, comparing those keywords to the data record, some street names that could be matched include Main, Massachusetts, and even Damascus.

Example B helps demonstrate how the children nodes may be used. In Example B, the search query is the phrase “stronger recommendation.” The trie data structure may search for alternative keywords for strong such as powerful or muscular. However the word “stronger” may already be the keyword. If a keyword was only “strong” the trie data structure may remove characters from the full selection of the inquiry phrase or set of characters to complete the search. For example, the search may include alternative suffixes such as “est.” Alternatively, the keyword from “stronger” may only be the first three characters, and the children nodes may highlight other endings such as “ung” to attain the keyword “strung” and several suffixes to be compared against the record.

Trie data structures are very helpful in the field of searching pluralities of records. Trie data structures can help complete search queries where only a few characters are known (like only “ma” in the street) or where there are many alternative words (“strong”).

Further, examine the problem with traditional database searches; a database with every variation of certain words is cumbersome. For example, if a search was executed for streets that begin with “ch,” a prepopulated dictionary of street names would be cumbersome to create. But, the children nodes can define characters that precede and/or follow the characters “ch” to make street names such as “Churl” and “Uchiha.”

The trie data structure may also not have any predefined included text. For example, if a user is searching a public database for a list of names, addresses, and salaries for all individuals but with no provided restraints. There may be no restrictions on letters that must be included, unlike some examples above. The first link may search for names. The trie data structure and maximum keyword length may execute first. The database of keywords may be a database of first and last names. A record of the public database is searched to find a name with the maximum keyword length as the longest keyword in the keyword database.

The maximum keyword length is the length of the longest keyword in the trie data structure. By defining the maximum keyword length the number of potential matches decreases within the record. Defining a maximum keyword length also decreases the number of alternatives that can be generated by the children nodes using the trie data structure. Because limiting the maximum keyword length decreases matches and potential alternatives as described, the computer hardware is proportionally taxed less, and is able to complete searches at a faster rate. Children nodes may not be restricted by the maximum keyword length.

Another search element within the link is a before section. The before section includes a first regular expression and a first maximum match length. A first regular expression is a pattern describing a certain amount of text. A first regular expression operates by seeking patterns of text that match predefined criteria. Limiting the number of characters to match patterns of text allows several benefits. One benefit of limiting the number of characters is reducing the number of potential matches from a record which in turn can decrease hardware load.

The before section searches for matches adjacent to the start of the keyword location within the data record. For a given keyword location, the before section will seek matches for characters that run up to the start of that keyword. The amount of characters that the before section will search before that keyword is limited by the first maximum match length. This section before the keyword is also defined as the keyword match minus the first maximum match length.

This before section may take place after the trie data structure and maximum keyword length. If so, the before section is executed against the record using the first regular expression from a start of the keyword match minus the first maximum match length. By subtracting the first maximum match length from the start of the keyword match, a set of characters are defined for the before section to search.

Example A from above can illustrate this search element. After the trie data structure and maximum keyword length have been found, the search may continue to the next search element, which may be the before section. The previous search element had found several street names, Main, Massachusetts, and Damascus. Now, the before section will take each of these matches, and search for matches adjacent to the start of the keyword location within the data record. Examining the match “Main,” the before section will search for matches that precede the first character of this match, “m.” Examine the match “Damascus”, the first character of this match is “d.” For the simple Example A where the search query was only for streets with “ma,” there is no before section to be matched that is—the search is not for a phrase or set of characters. Although the before section will be completed, it will find all previous matches to, again, match the previous search element because all previous matches satisfy the criteria of the before section.

To slightly alter example A, see example A.1 to illustrate the before section. Example A.1, if the search query was for a street beginning with “First ” and some inclusion of the characters “ma” with the first maximum match length of six characters. The same matches are found in the previous search element which include Main, Massachusetts, and Damascus. Here, the before section will seek matches that precede each of these matches, seeking at a maximum length of six characters, if their match includes “First”. Some matches found may include “First Massachusetts” and “First Main”.

Another search element within the link is the after section. The after section, similar to the before section, searches for matches at the end location of the keyword and up until the after pattern maximum length. The end location is the start adjacent to the end of the keyword. In other words, the after section will seek matches for characters that run after the end of the keyword. The after section includes a second regular expression and a second maximum match length. The second regular expression operates similarly to the first regular expression, where the second regular expression is a pattern describing a certain amount of text. The second maximum match length defines the number of characters the after section will search.

In operation, the after section may follow a before section match. The after section is executed against the record using the second regular expression starting at an end location of the keyword match plus the second maximum length.

Example A from above can illustrate this search element. After the before section has been executed, the search may continue to the next search element, which may be the after section. The same streetnames were matched and included Main, Massacussetts, and Damascus. For the simple Example A where the search query was only for streets with “ma,” there is no after section to be matched, that is—the search is not for a phrase or set of characters. Although the after section will be completed, it will find all previous matches to, again, match the previous search element because all previous matches would satisfy the criteria of the after section.

To slightly alter example A, see example A.2. Example A.2, if the search query was for a street with the inclusion of the characters “ma” and ending with “la” with the second maximum match length of six characters. The same matches are found in the previous search element which include Main, Massachusetts, and Damascus. Here, the after section will seek matches for six characters at the end of the keyword. For example, Damascus the after section will seek matches after the “s”. The after expression may find matches such as “Damascus Lane” and “Damascus Lake”.

In total, each of the search elements are present in one link of the plurality of links that make up the chain structure. Each link includes a trie data structure and a maximum keyword length, a before section and an after section. As the search proceeds, the record is searched in the order of the links and the order of the search elements.

The chain structure is executed upon receiving a search query from a user. A search query includes a textual phrase. The textual phrase may simply comprise a set of parameters to search for characters of text, for example the textual phrase may be like in example A.1 the search query was for a street beginning with “First” and some inclusion of the characters “ma” with the first maximum match length of six characters. The textual phrase may be more complex including several segments of distinct data. This may include items from Example C. Example C has a search query for an address with some combination of characters “ma”, and the word “first” before and the word “square” after. Further Example C is also searching for the name of the person that is some derivative of the name “Ben”.

In response to receiving the search query, a first link in the plurality of links may be executed. The first link may search the first segment of a textual phrase. The first search element in the link may correspond to the trie data structure and the maximum keyword length, and search for a keyword match within the record.

Example C demonstrates how, after the search query is received, the chain structure may be executed. The first link of the chain structure may only define the address portion of the query for example C. The link may define the order of execution of the search elements as - first executing the trie data structure and the maximum keyword length, then executing the before section, then executing the after section and potentially other search elements. For Example C, the trie data structure may find several streets with “ma” such as Damascus. Then the before section may look before the locations of “Damascus” for the characters “first.” The before section may find streets such as “First Damascus Square” and “First Damascus Park”. The after section will then search from the results of the before section for terms with “Square” after the keyword. The after section would therefore find “First Damascus Square” as the result. The chain search metadata may then continue with a separate link for the name of the person that is some derivative of the name “Ben.”

As the search is executed, execution metrics may be collected. Execution metrics are collected during the execution of each link of the plurality of links of the chain, the execution metrics include the number of matches found from each of the plurality of links. In some embodiments the execution metrics include factors such as: the amount of time required to execute each link of the plurality of links; the location of each match, wherein the location is the part of the record where the match was found; and previous execution metrics from previous searches.

In embodiments where the amount of time is used in evaluating the execution metrics, the execution metrics include a total amount of time and an average time required to execute each of the plurality of links. Including the amount of time may be helpful in comparison to the number of matches found. Some links may find no matches but require more time to be searched. Including the average amount of time is another valuable metric, as the amount of time it takes to search per record may be useful when dynamically adjusting the order of link execution.

These execution metrics once collected, are used to dynamically adjust the order of link execution within the chain structure. This is an adaptive mode for the search. Here, the execution metrics are collected to dynamically optimize the order of link execution by analyzing the cost of executing while searching records from a single data source, such as a file or database table.

Dynamically adjusting the order of link execution provides a myriad of benefits over traditional search methodologies. Traditional methods of completing only one type of search struggle to quickly identify complex patterns containing keywords within textual data records.

In comparison to the present invention, if a search query has many criteria such as seeking an address, salary, name, and date of birth of an individual—with each search criteria defining its own link (address as link 1, name as link 2, salary as link 3, date of birth link 4), some links may be completed faster than others. A link may be completed faster when it returns fewer matches to the search query. Fewer matches from one link reduce the load on a system for additional links, particularly when that link is adjusted to be utilized as the first link.

For example, the chain structure may have four links corresponding to a complex search query seeking a seeking an address, salary, name, and date of birth for an individual. In this scenario, more matches may be found from a database for a salary then for a link searching for an uncommon name. After one set of chain structure is completed, the execution metrics may be collected, evaluated, and the order of execution of the links adjusted.

In some embodiments, a testing period is executed to determine an initial order of link execution. This initial order is determined by executing the search for a predetermined number of records of the plurality of records, each iteration of the search using a different order of link execution to build a base of execution metrics. During this testing period, links in the chain are executed in different orders for a limited number of records. Then, at the end of the sampling period, the collected metrics are evaluated and the fastest execution order is determined. This fastest execution order may still be adjusted, however, based on the execution metrics of subsequent links after the search of additional records.

For example, this embodiment with a testing period would be executed for 10 records. If there are five links in the chain structure, then the order of the links would be set to different orders. In another embodiment, the different order of link execution includes using a different first link as the first link in the order of link execution. In the same example, if there are five links in the chain structure, potentially each link is placed as the first link twice. In other embodiments, the order of link execution within the chain structure is dynamically adjusted after at least one record of the plurality of records is searched.

In another embodiment, if no match is found along any element of the plurality of links within the chain for the record, the search is repeated using the first link of the plurality of links within the chain structure for a subsequent record of the plurality of records. Each element of the plurality of links must be satisfied as a search is sequentially completed. For clarity, each element includes the search elements within each link. As each link in the chain is executed, the individual search element must be satisfied to proceed to the subsequent element within the same link.

For example, during a search the trie data structure and maximum search length present a match, in this case, the next search element within the link is executed. The next search element may be a before section. The before section is executed and no matches result. If so, no more search elements are executed in the link or the chain structure for that record. Instead, execution metrics may be collected on the link. This data may be used to set the execution order of the chain. Finally, the next record may be searched.

In another embodiment, one link may find a match, proceeding to the subsequent link, but for the subsequent link, one search element may not find a match. In this case, similar to the above, instead, execution metrics may be collected on the link. This data may be used to set the execution order of the chain. Finally, the next record may be searched.

In other embodiments, the order of link execution within the chain structure is dynamically adjusted to optimize the search for the fastest execution order. In this embodiment, the dynamic adjustment of the link execution is prioritized using the execution metrics to find the fastest execution order.

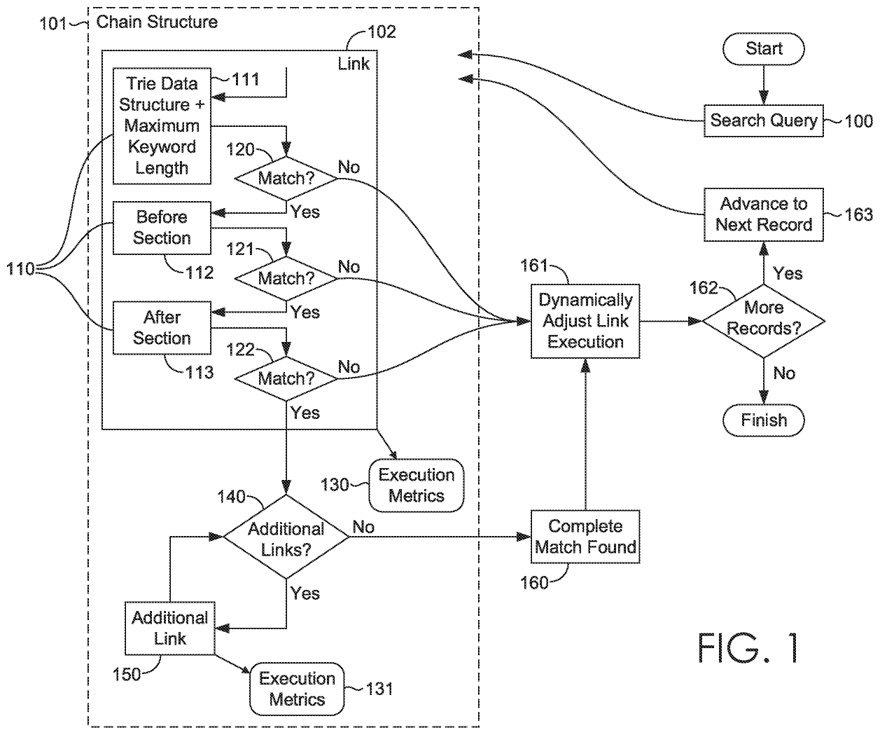

FIG. 1 displays a flow chart of an example process for searching using the chain search metadata. In the shown embodiment, a search query 100 is received from the user. The search query 100 comprises a textual phrase from the user and may have several search criteria, such as salary, address, and name of an individual.

In response to receiving the search query, a search is initiated using the chain structure 101. The chain structure 101 is made up of a plurality of links, where each link of the plurality of links comprises a series of search elements. An exemplary link 102 is shown as well as additional link 150. In embodiments, each link, including the exemplary link 102 includes three search elements 110. The three search elements 110 are the trie data structure and maximum keyword length 111, the before section 112, and the after section 113.

As a search query 100 is received, the search executes the chain of links sequentially. Here, the first link in the chain structure 101 is the exemplary link 102. Different portions of the search query 100 may be handled concurrently by various links; here, the exemplary link 102 may be searching for an address while other links may seek to match a name or a salary. For this exemplary link 102, the search query 100 is first input to the trie data structure and maximum keyword length 111. In some embodiments, once the trie data structure and maximum keyword length 111 completes, the exemplary link 102 determines if there was a trie data structure match 120. If a match is found, the before section 112 is executed.

In other embodiments, the search elements 110 within the chain are executed sequentially regardless of whether there is a match.

In FIG. 1, the before section is executed after the trie data structure and maximum keyword length 111 if there is a trie data structure match 120. Once the before section 112 is executed, the exemplary link 102 determines whether there has been a before search match 121. If there has been a before search match 121, the search continues to the after section 113.

Once the after section 113, is completed, the exemplary link 102 determines if there has been an after section match 122. If there has been an after section match 122, the search continues to determine if there are additional links 140.

After the exemplary link 102 is executed, execution metrics 130 are collected from the exemplary link 102. If it is determined that there are additional links 140, then the search will continue to the additional link 150. The additional link 150 proceeds similarly to the description above for exemplary link 102. Once the additional link 150 is executed and a match found, it is again determined if there are additional links 140. This process may continue of determining additional links 140 and executing the additional link 150 until all links of the chain search metadata 101 are executed. Once it is determined additional links 140 are not present, a complete match 160 is found.

After each additional link 150 is executed, execution metrics 131 are collected for each additional link 150.

In some embodiments, the additional link 150 may have a different order of execution for the search elements 110. In some embodiments, the additional link 150 has similar characteristics to the exemplary link 102, where if any of the search elements 110 determine there was not a match, the search does not proceed to the subsequent search elements 110.

The complete match 160 in the present embodiment is when every link of the chain structure 101 has found a match. This complete match 160 may be displayed to the user who submitted the search query 100.

Once a complete match 160 is found, there may be a dynamic adjustment of link execution 161. The dynamic adjustment of link execution 161, operates by taking the execution metrics 130 from the exemplary link 102 and the execution metrics 131 from each additional link 150 that was executed. The information collected may take into account various factors such as the number of matches found. In one embodiment, links that found no results are prioritized over other links, and the dynamic adjustment of link execution 161 reorganizes the links to place links with no results first in the order of execution of the chain structure 101.

If no trie data structure match 120, before search match 121, or after section match 122 are found, in some embodiments the execution of the link is stopped and no further search elements 110 are executed. In this embodiment execution metrics 130 and, if an additional link 150 is stopped, execution metrics 131 are collected, no complete match 160 is found, and instead the search proceeds to the dynamic adjustment of link execution 161.

Once the dynamic adjustment of link execution 161 is completed, the search determines if there are more records 162. If there are more records to be searched the search advances to the next record 163 and the search metadata 101 is executed against that record. If it is determined there are no more records, then the program ends.

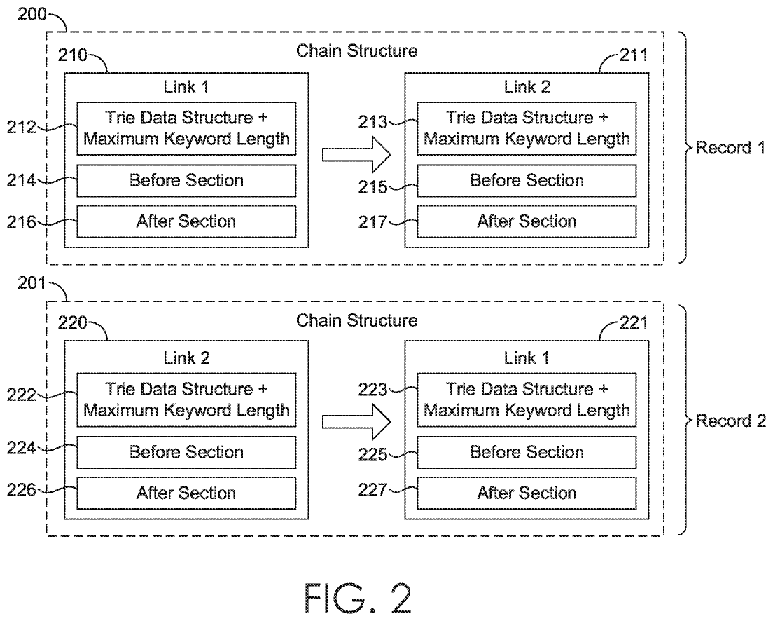

Moving on to FIG. 2, an example is shown of how the order of link execution may change. For two records, the dynamic adjustment of link execution may reorder links dependent on their execution metrics. Shown in FIG. 2 is the result from two records. In this embodiment a first execution of the search corresponding to the chain structure 200 is shown and a second execution of the search corresponding to the chain structure 201 is shown. The first execution of the search corresponding to the chain structure 200 has two links, a first link 210 and a second link 211. The first link 210, like all links in the chain structure 200 includes a trie data structure and a maximum keyword length 212, a before section 214, and an after section 216. Similarly, the second link 211 has trie data structure and a maximum keyword length 213, a before section 215, and an after section 217. For a first record, the first execution of the search is executed from the first link 210 to the second link 211. Execution metrics are collected from each link and the dynamic adjustment of link execution may reorder the execution of the links.

If a dynamic adjustment of link execution is made, for a second record the second execution of the search corresponding to the chain structure 201 may be as shown. The second execution of the search corresponding to the chain structure 201 shows the second link 220 is to be executed before the first link 221. The second link 220 contains the same search elements as before and in the same order; a trie data structure and maximum keyword length 222, a before section 224, and an after section 226. Further the first link 221 similarly has the same search elements, a trie data structure and maximum keyword length 223, a before section 225, and an after section 227.

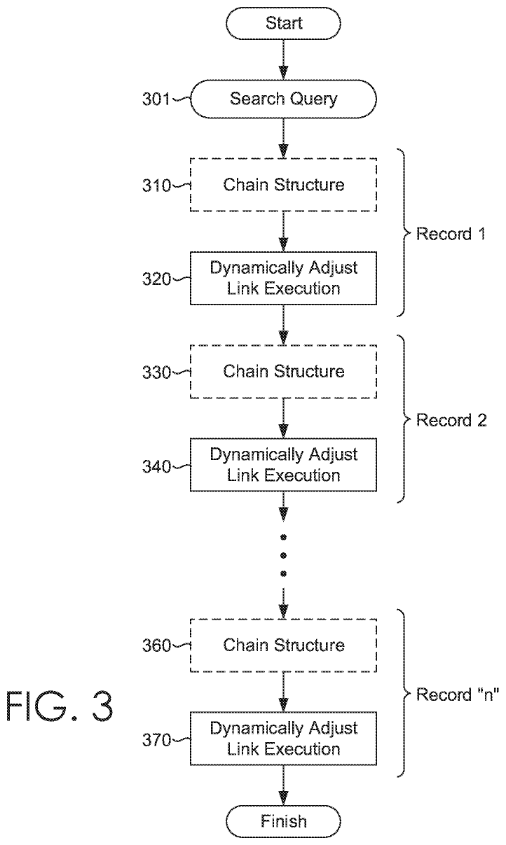

FIG. 3 displays how the dynamic adjustment of link execution occurs after each execution of the search and for each record. In one embodiment, a search query 301 is received and a search corresponding to chain structure 310 is executed on a first record. Based on the execution metrics of the search corresponding to chain structure 310 there is a first dynamic adjustment of link execution 320. This process proceeds to the second record, with the chain structure 330 executed. This is followed by a second dynamic adjustment of link execution 340. The process repeats for “n” number of records, where the search corresponding to chain structure 360 is executed and there is an n′th dynamic adjustment of link execution 370 based on the execution metrics of the search corresponding to chain structure 360.

In one embodiment, the execution metrics from every previous iterations of the search are used to dynamically adjust link execution. This can be shown in FIG. 3, at record “n”. Here, in the embodiment described, the dynamic adjustment of link execution 370 would include the execution metrics from the search corresponding to chain structure 360 and every previous set of execution metrics from “n-1” records.

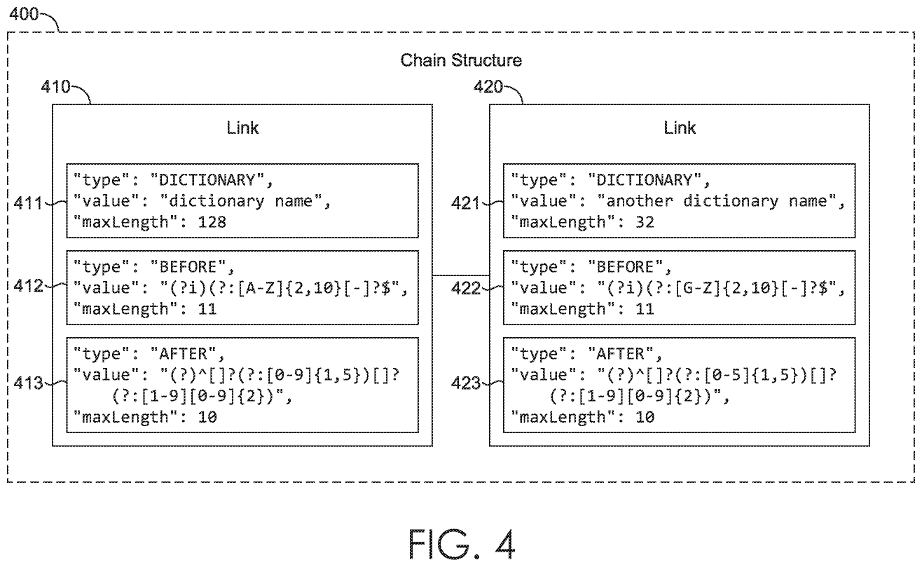

FIG. 4 displays exemplary chain search metadata (the aggregation of each of the search elements 411, 412, 413, 421, 422, 423) comprising various search elements for each link. Shown is chain structure 400 are two links, a first link 410 and a second link 420. The first link 410 shows exemplary search elements 411 for the trie data structure and maximum keyword length. The first link 410 also shows exemplary search elements 412, 413 for a before section and an after section, respectively. Similarly, the second link 420 shows exemplary search elements 421, 422, 423 for the trie data structure and maximum keyword length, the before section, and the after section, respectively.

Referring still to FIG. 4, one search element 411, the trie data structure and maximum keyword length, shows the “type” of keyword database that may be used, such as a “Dictionary” of terms. The “value” of that database is the “Dictionary Name”. Further, the maximum keyword length is shown for search element 411 as 128 characters. Note that this keyword length can be different for each link, such as the value shown in search element 420 with maximum length 32.

Another search element 412 of link 410 shows the type of search, which is a “before” section. The search element 412 also indicates the values that may be searched by the before section, which may be any letter from A-Z and numbers 2-10. The first maximum match length is shown as 11 characters. As described herein, the values of these search elements for the before section may be different for different links.

Another search element 413 of link 410 shows the type of search, which is an “after” section. The search element 413 also indicates the values that may be searched by the after section, which is seeking numbers up to a second maximum match length of 10 characters.

Having identified various elements of the search system, it is noted that any number of elements may be employed to achieve the desired functionality within the scope of the present disclosure.

Various functions described herein as being performed by one or more entities may be carried out by hardware, firmware, and/or software. For instance, various functions may be carried out by a processor executing instructions stored in memory.

Having described an overview of embodiments of the present invention, an exemplary operating environment in which embodiments of the present invention may be implemented is described below in order to provide a general context for various aspects of the present invention. Referring reference now to FIG. 5, an exemplary operating environment for implementing embodiments of the present invention is shown and designated generally as computing device 500. Computing device 500 is but one example of a suitable computing environment and is not intended to suggest any limitation as to the scope of use or functionality. Neither should the computing device 500 be interpreted as having any dependency or requirement relating to any one or combination of components illustrated.

The technology of this disclosure may be described in the general context of computer code or machine-useable instructions, also known as machine readable medium, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The described technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With continued reference to FIG. 5, computing device 500 includes a bus 510 that directly or indirectly couples the following devices: memory 512, one or more processors 514, one or more presentation components 516, input/output ports 518, input/output components 520, and an illustrative power supply 522. Bus 510 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that this is the nature of the art, and reiterate that the diagram of FIG. 5 is merely an illustration of a computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory, or other memory technology; CD-ROM; digital versatile disks (DVD) or other optical disk storage; magnetic cassettes, magnetic tape, magnetic disk storage, or other magnetic storage devices; or any other medium that can be used to store the desired information and that can be accessed by computing device 500. Computer storage media excludes signals per se.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, communication media includes wired media, such as a wired network or direct-wired connection, and wireless media such as acoustic, RF, infrared, and the like. Combinations of any of the above should also be included within the scope of computer-readable media.

Memory 512 includes computer storage media in the form of volatile and/or nonvolatile memory. The memory may be removable, non-removable, or a combination thereof. Exemplary hardware devices include solid-state memory, hard drives, optical-disc drives, etc. Computing device 500 includes one or more processors 514 that read data from various entities such as memory 512 or I/O components 520. Presentation component(s) 516 present data indications to a user or other device. Example presentation components include a display device, speaker, printing component, vibrating component, etc.

I/O port 518 allows computing device 800 to be logically coupled to other devices including I/O components 520, some of which may be built in. Illustrative components include a microphone, joystick, game pad, satellite dish, scanner, printer, wireless device, etc.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies.

From the foregoing, it will be seen that this technology is one well adapted to attain all the ends and objects described above, including other advantages which are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated the accompanying drawings is to be interpreted as illustrative and not in a limiting sense.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters” using communication media described herein. Also, the word “initiating” has the same broad meaning as the word “executing or “instructing” where the corresponding action can be performed to completion or interrupted based on an occurrence of another action. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A system comprising:
at least one processor; and
computer readable memory storing computer usable instructions that, when executed by the at least one processor, cause the at least one processor to:
receive chain search metadata, the chain search metadata defining a plurality of links within a chain structure, each link of the plurality of links comprising a trie data structure and a maximum keyword length, a before section comprising a first regular expression and a first maximum match length, and an after section comprising a second regular expression and a second maximum match length;
receive a search query from a user, the search query comprising a textual phrase;
in response to receiving the search query, search a segment of the textual phrase, using a first link of the plurality of links within the chain structure corresponding to the trie data structure and the maximum keyword length, for a keyword match within a record of a plurality of records;
upon identifying a match, execute the before section against the record using the first regular expression from a start of the keyword match minus the first maximum match length;
upon identifying a before section match, execute the after section against the record using the second regular expression starting at an end location of the keyword match plus the second maximum length;
collect execution metrics during execution of each link of the plurality of links of the chain, the execution metrics comprising the number of matches found from each of the plurality of links; and
dynamically adjust an order of link execution within the chain structure corresponding to the collected execution metrics.

2. The system of claim 1, further comprising determining an initial order of link execution by executing the search for a predetermined number of records of the plurality of records, each iteration of the search using a different order of link execution to build a base of execution metrics.

3. The system of claim 2, wherein the different order of link execution includes using a different first link as the first link in the order of link execution.

4. The system of claim 1, wherein the execution metrics further comprises an amount of time required to execute each link of the plurality of links.

5. The system of claim 4, wherein the amount of time required to execute each of the plurality of links includes a total amount of time and an average time required to execute each of the plurality of links.

6. The system of claim 1, wherein the execution metrics includes the location of each match, wherein the location is the part of the record where the match was found.

7. The system of claim 1, wherein the execution metrics include previous execution metrics from previous searches.

8. The system of claim 1, wherein the order of link execution within the chain structure is dynamically adjusted after at least one record of the plurality of records is searched.

9. The system of claim 1, wherein if no match is found along any element of the plurality of links within the chain for the record, repeating the search using the first link of the plurality of links within the chain structure for a subsequent record of the plurality of records.

10. The system of claim 1, wherein the order of link execution within the chain structure is dynamically adjusted to optimize the search for the fastest execution order.

11. A computer storage medium storing computer-useable instructions that, when used by at least one computing device, cause the at least one computing device to perform operations comprising:
receiving chain search metadata, the chain search metadata defining a plurality of links within a chain structure wherein each link of the plurality of links comprises:
a trie data structure and a maximum keyword length;
a before section comprising a first regular expression and a first maximum length; and
an after section comprising a second regular expression and a second maximum length;
receiving a search query from a user comprising a textual phrase; and
in response to receiving the search query, in accordance with the chain structure, proceeding sequentially along the plurality of links to identify matches within a plurality of records.

12. The machine readable medium of claim 11, wherein the order of the plurality of links is static.

13. The machine readable medium of claim 11, further comprising identifying a complete match when each link of the plurality of links identifies a match.

14. The machine readable medium of claim 11, further comprising:
collecting execution metrics during execution of each link of the plurality of links of the chain structure, the execution metrics comprising the number of matches found from each of the plurality of links; and
dynamically adjusting an order of link execution within the chain corresponding to the collected execution metrics.

15. The machine readable medium of claim 14, wherein the execution metrics further comprise a total amount of time and an average time required to execute each of the plurality of links.

16. The machine readable medium of claim 14, wherein the execution metrics include a location of a match, the location being a part of the record where the match was found.

17. The machine readable medium of claim 14, wherein the execution metrics include the execution metrics from previous searches.

18. The machine readable medium of claim 14, wherein the order of link execution within the chain structure is dynamically adjusted after at least one record of the plurality of records is searched.

19. The machine readable medium of claim 14, further comprising further comprising determining an initial order of link execution by executing the search for a predetermined number of records of plurality of records, each iteration of the search using a different order of link execution to build a base of execution metrics.

20. A method executed by a computer comprising:
receiving chain search metadata, the chain search metadata defining a plurality of links within a chain structure wherein each link in the plurality of links comprises:
a trie data structure and a maximum keyword length;
a before section comprising a first regular expression and a first maximum length; and
an after section comprising a second regular expression and a second maximum length;
receiving a search query from a user a textual phrase;
searching, in accordance with the chain search metadata, by proceeding sequentially along the plurality of links;
collecting execution metrics during execution of each link of the plurality of links of the chain structure, the execution metrics comprising a number of matches identified by each link of the plurality of links, a total amount of time and an average time required to execute each link of the plurality of links, and a location of each match within a record; and
dynamically adjusting an order of link execution within the chain structure corresponding to the collected execution metrics after at least one record of a plurality of records is searched; and
upon dynamically adjusting the order of link execution, repeating the search for a subsequent record of the plurality of records.
